(19) United States
(12) Patent Application Publication
(10) Pub. No.: US 2024/0288273 A1
(43) Pub. Date: Aug. 29, 2024

(54) SYSTEMS AND METHODS FOR RESPONDING TO ROAD CHANGES WITH CONDITIONAL CONTRACTION HIERARCHIES

(71) Applicant: Verizon Patent and Licensing Inc., Basking Ridge, NJ (US)

(72) Inventors: Hayden Sean WHITE, Kaiapoi (NZ); Nathan M. ROBINSON, Christchurch (NZ)

(73) Assignee: Verizon Patent and Licensing Inc., Basking Ridge, NJ (US)

(21) Appl. No.: 18/174,834

(22) Filed: Feb. 27, 2023

(51) Int. Cl. G01C 21/34

(52) U.S. Cl. CPC G01C 21/3453; G01C 21/3415

(57) ABSTRACT

A device may receive a road edit associated with an initial contraction hierarchy, and may identify paths and shortcut paths with changed costs due to the road edit. The device may create an index mapping witness paths to unnecessary candidate shortcut paths, and may examine pairs of incoming and outgoing links, of the initial contraction hierarchy, to generate candidate shortcut paths. The device may determine whether each candidate shortcut path is required due to the road edit, and may identify required candidate shortcut paths. The device may determine whether each of the required candidate shortcut paths is associated with a witness path, and may add required candidate shortcut paths, not associated with witness paths, to the initial contraction hierarchy to generate a modified contraction hierarchy. The device may generate modified routing data.

### BACKGROUND

Contraction hierarchies are techniques applied in graph theory. Contraction hierarchies may be utilized with vehicle navigation applications, systems, and/or the like, where a driver wishes to travel from a starting location to a destination location using a quickest possible route.

### BRIEF DESCRIPTION OF THE DRAWINGS

FIGS. 1A-1I are diagrams of an example associated with responding to road changes with conditional contraction hierarchies.

FIG. 2 is a diagram of an example environment in which systems and/or methods described herein may be implemented.

FIG. 3 is a diagram of example components of one or more devices of FIG. 2.

FIG. 4 is a flowchart of an example process for responding to road changes with conditional contraction hierarchies.

### DETAILED DESCRIPTION OF EXAMPLE EMBODIMENTS

The following detailed description of example implementations refers to the accompanying drawings. The same reference numbers in different drawings may identify the same or similar elements.

Contraction hierarchies may be utilized to restrict a set of links (e.g., roads) that are followed to improve performance of routing queries while preserving optimal routes. A contraction hierarchy may optimize a metric associated with a route, such as travel time. In a contraction hierarchy, intersections are represented by nodes or vertices and roads are represented by edges connecting with the nodes. An edge weight represents a time it takes to drive along a segment of the road represented by the edge. For example, a path from node A to node B may include a sequence of edges (e.g., road sections), and a shortest path may be a path with a minimal sum of edge weights among all possible paths. A shortest path in a road network may be computed using Dijkstra's algorithm, but given that a road network may include of tens of millions of vertices, this is impractical. A contraction hierarchy is a method that decreases a required time for determining shortest paths in road networks based on exploiting properties of graphs representing the road networks. The decrease in the required time may be achieved by creating shortcuts in a preprocessing phase which are then used during a shortest path query to skip over unimportant vertices. This technique is based on the observation that road networks are highly hierarchical. However, road edits or changes (e.g., live updates to a route, a car crash, and/or the like) associated with a contraction hierarchy may occur and may change shortcuts that were not accounted for in the contraction hierarchy. Thus, current techniques for handling road changes associated with a contraction hierarchy consume computing resources (e.g., processing resources, memory resources, communication resources, and/or the like), networking resources, and/or other resources associated with completely reperforming the contraction hierarchy based on the road changes, reconstructing a route based on completely reperforming the contraction hierarchy, removing shortcuts that are no longer necessary because of the road changes, and/or the like.

Some implementations described herein provide a routing system that responds to road changes with conditional contraction hierarchies. For example, the routing system may provide, to a vehicle, initial routing data created with an initial contraction hierarchy, and may receive a road edit associated with the initial contraction hierarchy. The routing system may identify paths and shortcut paths, of the initial contraction hierarchy, with changed costs due to the road edit, and may create an index mapping witness paths to unnecessary candidate shortcut paths, of the initial contraction hierarchy, based on the identified paths and shortcut paths. The routing system may examine pairs of incoming and outgoing links, for each of a plurality of nodes of the initial contraction hierarchy, to generate candidate shortcut paths, and may determine whether each of the candidate shortcut paths is required due to the road edit. The routing system may identify required candidate shortcut paths based on determining whether each of the candidate shortcut paths is required, and may determine whether each of the required candidate shortcut paths is associated with a witness path. The routing system may add one or more required candidate shortcut paths, not associated with witness paths, to the initial contraction hierarchy to generate a modified contraction hierarchy, and may generate modified routing data based on the modified contraction hierarchy, and may provide the modified routing data to the vehicle.

In this way, the routing system responds to road changes with conditional contraction hierarchies. For example, the routing system may rebuild portions of a contraction hierarchy that are affected by road edits or changes, and may integrate with conditional contraction hierarchies to enable conditional edits (e.g., changing of a vehicle height requirement, changing of a vehicle weight requirement, changing of vehicle length limits, driver-specific road edits, and/or the like). The routing system may trigger the rebuilding of portions of contraction hierarchy data and may subsequently provide rebuilt contraction hierarchy data to be used in routing modification. Thus, the routing system may conserve computing resources, networking resources, and/or other resources that would have otherwise been consumed by completely reperforming the contraction hierarchy based on the road changes, reconstructing a route based on completely reperforming the contraction hierarchy, removing shortcuts that are no longer necessary because of the road changes, and/or the like.

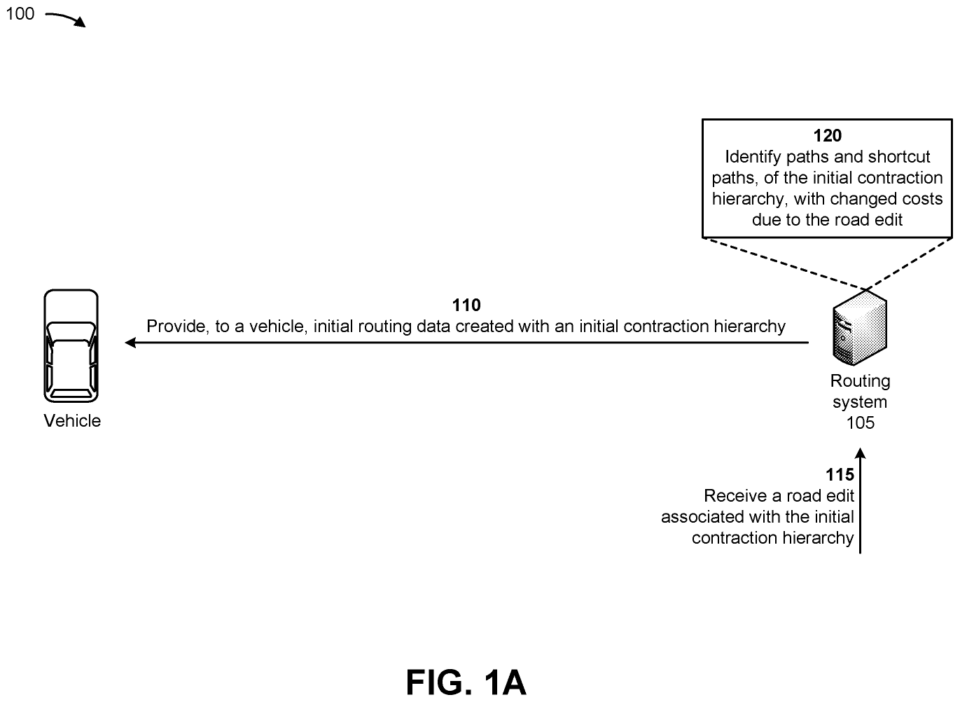

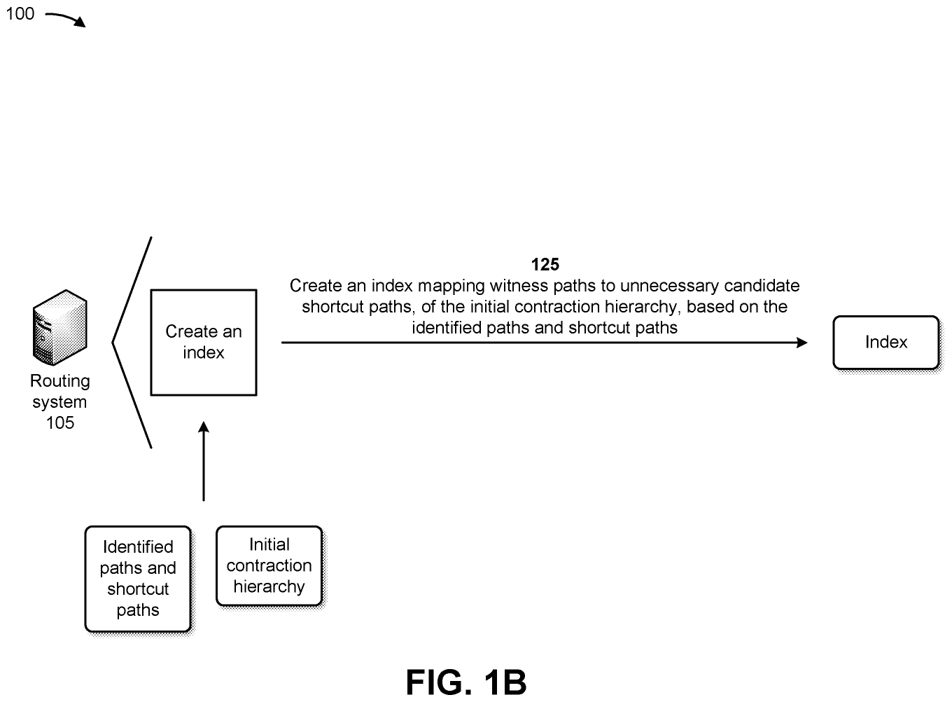

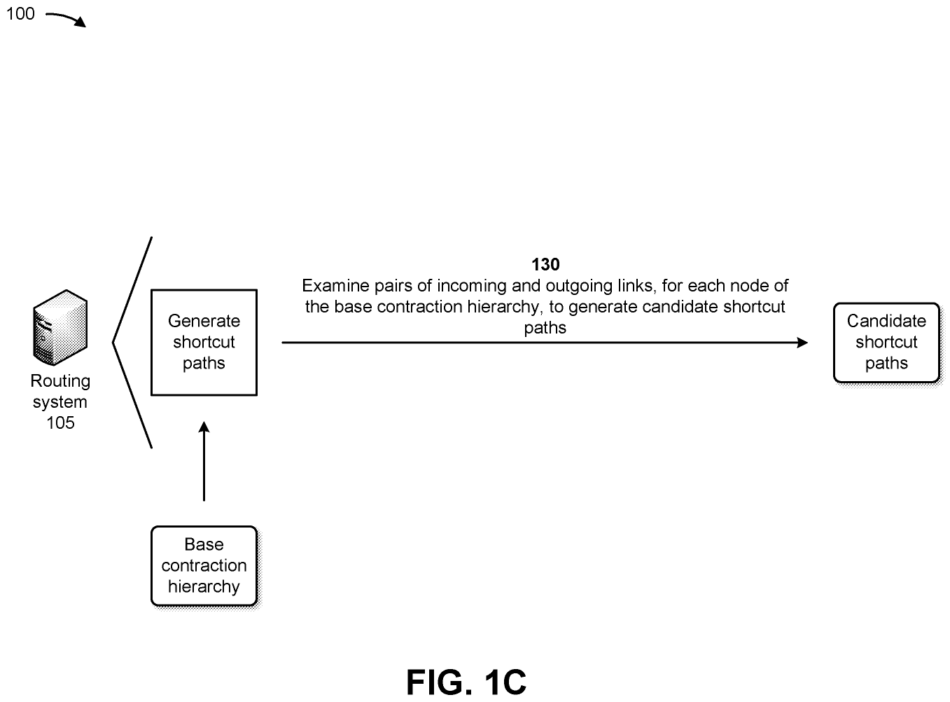

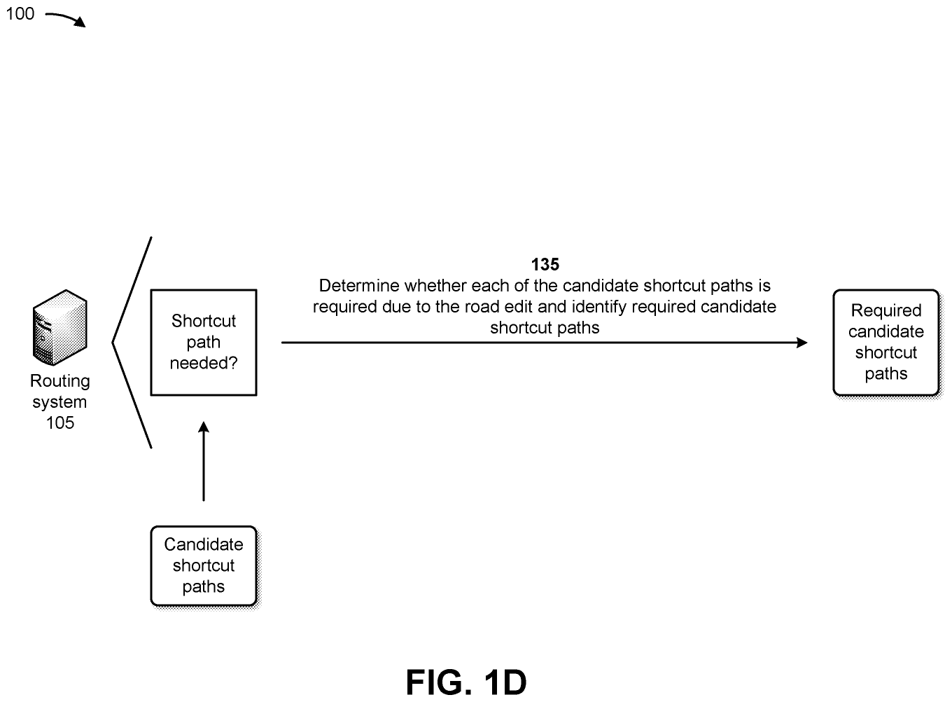

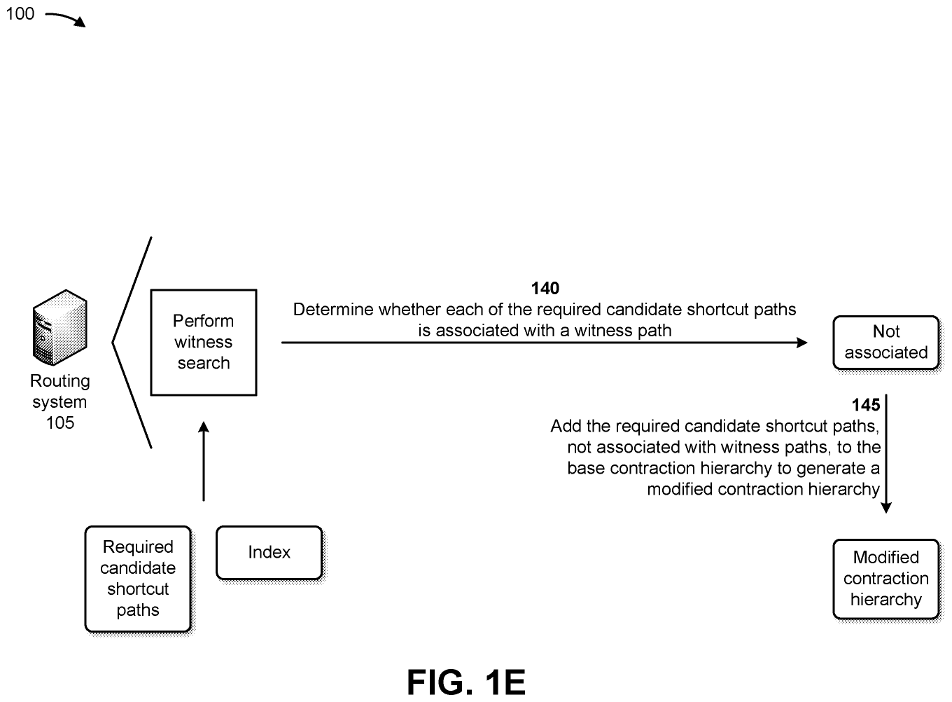

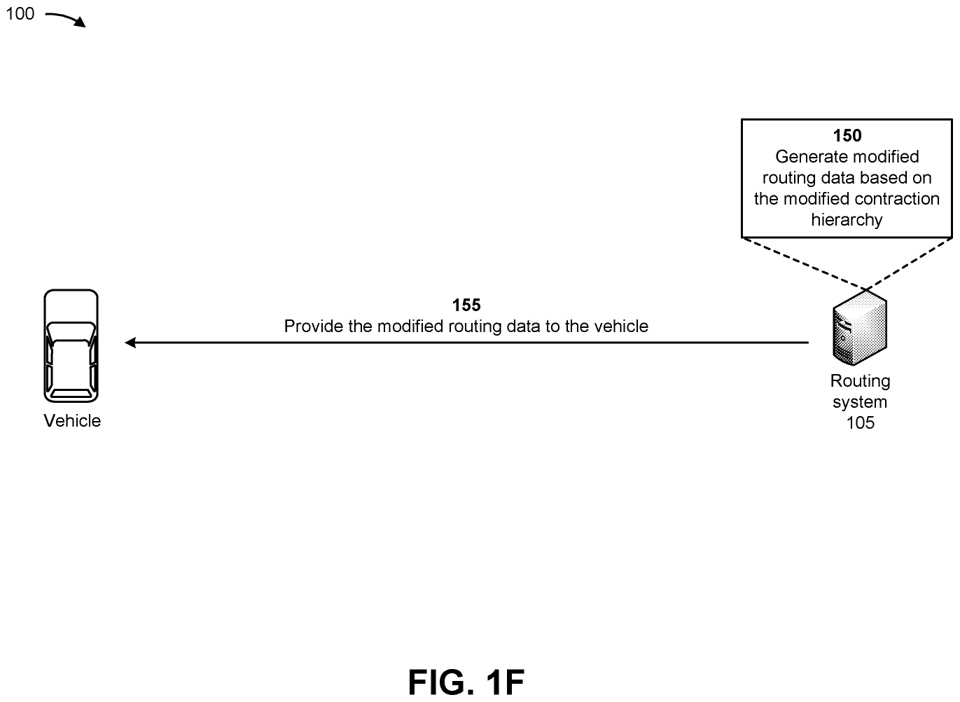

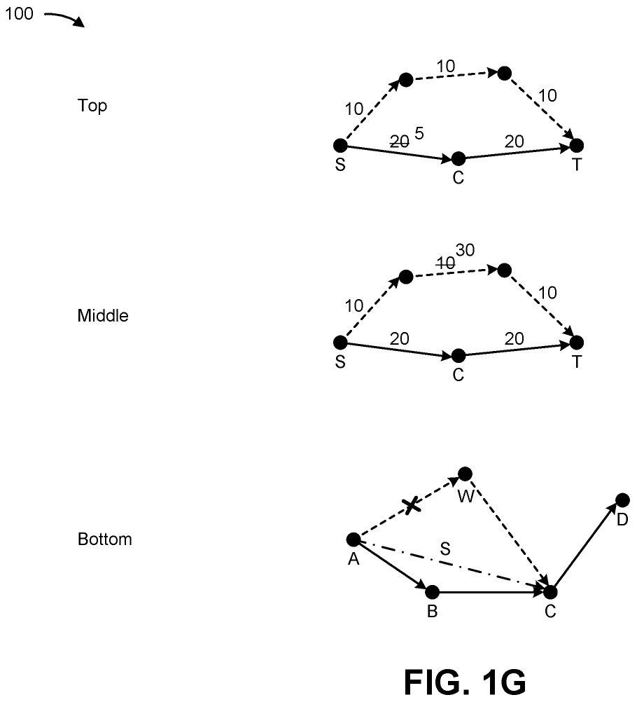

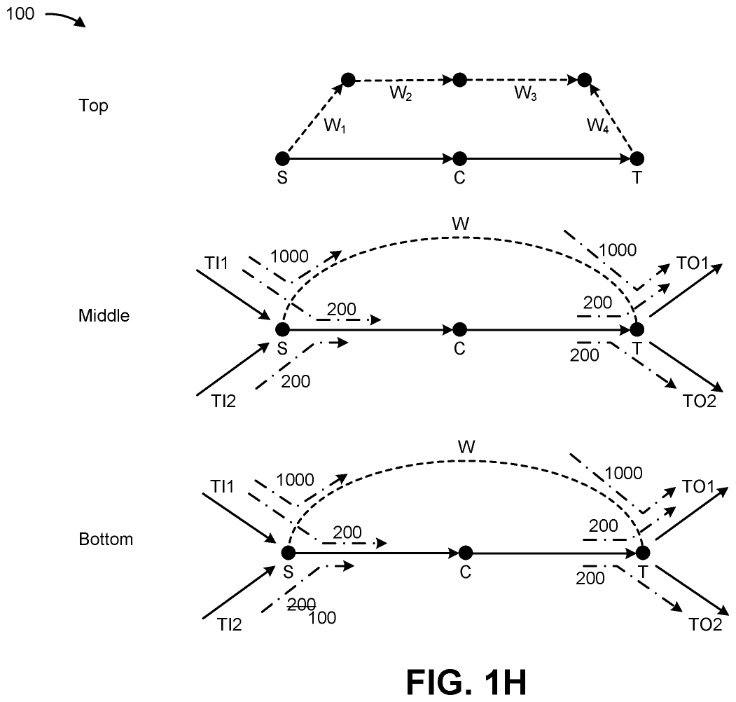

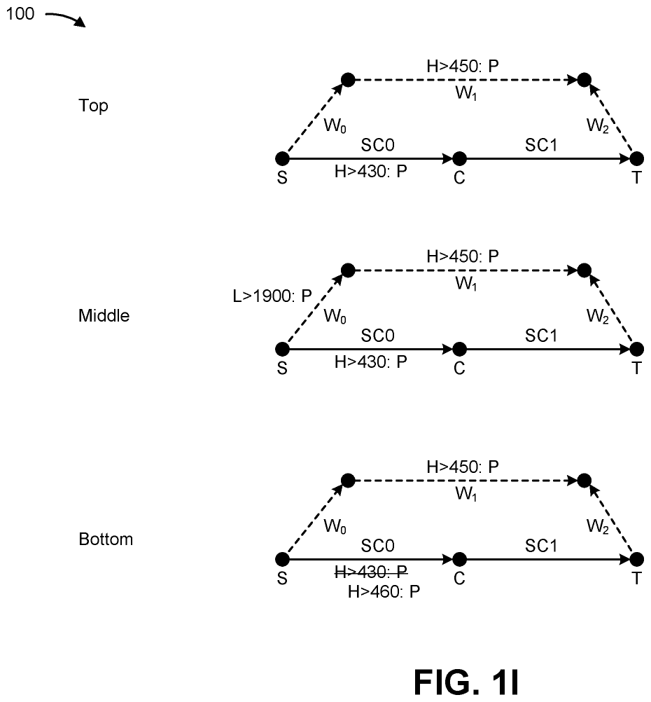

FIGS. 1A-1I are diagrams of an example 100 associated with responding to road changes with conditional contraction hierarchies. As shown in FIGS. 1A-1I, example 100 includes a vehicle associated with a routing system 105. The vehicle may include a car, a truck, a motorcycle, a bus, a boat, farm equipment, construction equipment, among other examples. In some examples, the vehicle may include an autonomous vehicle, a semiautonomous vehicle, or a non-autonomous vehicle. The routing system 105 may include a system that responds to road changes with conditional contraction hierarchies. Further details of the vehicle and the routing system 105 are provided elsewhere herein. Although implementations described herein depict a single vehicle, in some implementations, the routing system 105 may be associated with multiple vehicles.

As shown in FIG. 1A, and by reference number 110, the routing system 105 may provide, to a vehicle, initial routing data created with an initial contraction hierarchy. For example, the routing system 105 may receive, from the vehicle, a current location of the vehicle and a requested destination location to which the vehicle is to travel. The routing system 105 may calculate an initial route from the current location to the destination location and may generate the initial routing data for the initial route. The initial routing data may include data identifying roads, turns, landmarks, and/or the like that, if followed, will cause the vehicle to travel from the current location to the destination location. In some implementations, the initial routing data may include data identifying a least expensive route from a current location of the vehicle to a destination of the vehicle. The routing system 105 may provide the initial routing data to the vehicle, and the vehicle may receive the initial routing data and utilize the initial routing data for traveling to the destination location.

In some implementations, the routing system 105 may utilize an initial contraction hierarchy to create the initial routing data. A contraction hierarchy is a technique for restricting a set of links/roads that are followed to improve performance of routing queries while preserving optimal routes. A contraction hierarchy relies on the premise that most optimal road journeys follow an ascending-descending importance scheme that includes unimportant roads, followed by important roads, and followed by unimportant roads. During routing queries, if the routing system 105 limits a search to follow routes that adhere to the ascending-descending importance scheme, then a search space is dramatically reduced, making the search faster (e.g., because each node is expanded, which generates fewer child nodes that need to subsequently be expanded). The search will continue to find the optimal route in some cases, but in many cases will either find a suboptimal route, or will be unable to find a route as it would require traveling through links of lesser importance. This model may be modified to guarantee that the optimal route is always found by adding shortcuts that preserve the optimal routes under the ascending-descending importance scheme. A shortcut is a virtual link that represents traveling along multiple, less important roads, rather than just one as is the case with a normal link. This is a central idea of a contraction hierarchy.

A contraction hierarchy uses node importance, rather than link importance, but limits a routing search to find routes which initially follow links between nodes that monotonically increase in importance and then, at some point of the route, switches to following nodes that monotonically decrease in importance (e.g., priority). The contraction hierarchies described herein may include conditional contraction hierarchies, partitioned contraction hierarchies, and/or the like. The contraction hierarchy may replace a journey through unimportant roads with a shortcut. A precomputation stage of the contraction hierarchy may include adding all necessary shortcuts to preserve shortest paths between all nodes. An output of the precomputation stage may include data to be used for multiple routing queries. The precomputation stage begins with a full road network, and on each iteration, the lowest priority node that remains in the network is contracted. Contracting a node removes the node from the remaining network, because the node has a lower priority than every other node and, according to the importance scheme, the node is invisible to all remaining nodes. To make up for node contraction, the precomputation stage adds some shortcuts to preserve optimality. The lowest priority node may be determined according to a heuristic. The iteration continues until all nodes have been contracted. An output of this procedure is a contraction hierarchy, which is a road network augmented with priorities assigned to each node and shortcuts added to maintain optimality.

When a node (e.g., Node c) is contracted, the contracted node will be removed from the network. Thus, it may be determined if any shortcuts need to be added between neighboring nodes of the contracted node. A set of source (incoming) links and nodes, and a set of target (outgoing) links and nodes of the contracted node may be identified. For each pair (s, t) of source and target nodes of the contracted node, it may be determined whether a shortcut between the pair goes through the contracted node. If the shortcut goes through the contracted node, the shortcut may be added to the contraction hierarchy before the contracted node is removed. A bidirectional Dijkstra search may be executed on the remaining graph from node s to node t. If an alternative path to the shortcut (e.g., that is the same cost or cheaper) is identified, then the shortcut need not be added to the contraction hierarchy. The alternative path may be referred to a witness path. Once a set of shortcuts to add for all source and target pairs of the contracted node are identified, the shortcuts may be added to the contraction hierarchy and the contracted node (e.g., and any links associated with the contracted node) may be and removed. The precomputation stage may output the set of shortcuts to be added to the original road network and an importance/priority ordering of nodes determined by the order that the nodes are contracted.

A query stage may occur after the precomputation stage. In the query stage, an optimal path is found using bidirectional search. The query stage may include expanding forward from an origin location, expanding backward from a destination location, and only traversing towards nodes of higher priority. A candidate path may be found whenever the two searches meet. The query stand may output a lowest-cost candidate, as that is the optimal solution.

As further shown in FIG. 1A, and by reference number 115, the routing system 105 may receive a road edit associated with the initial contraction hierarchy. For example, the routing system 105 may receive the road edit associated with the initial contraction hierarchy from the vehicle, a map service system, and/or the like. In some implementations, the road edit may be associated with a change to a link cost of the initial contraction hierarchy, a change to a turn cost of the initial contraction hierarchy, a change to a conditional cost of the initial contraction hierarchy, and/or the like. In some implementations, the road edit includes a global road edit associated with real time traffic incidents and updates to map data, a driver-specific road edit associated with a requirement of a driver (or another user) of the vehicle, and/or the like.

Global road edits are associated with real time traffic incidents and/or recent updates on map data from map vendors. A cost of a path in a road network may be a sum of link costs. For example, if path A is cheaper than path B (e.g., path A costs 4 and path B costs 5), all vehicles may take path A. A global road edit may impose a road closure on one of the links on path A. As a result, path B may be considered the best route for all vehicles. In another example, path A may be cheaper than path B, but path A may only allow vehicles with lengths are no more than fifteen meters. Customers with vehicles less than fifteen meters may be recommended path A as a best route and a customer with a vehicle of seventeen meters may be recommended path B due to a violation of the length constraint. However, if a global road edit is applied, changing the length constraint to twenty meters, the customer with the vehicle of seventeen meters may be recommended path A.

Map data from vendors sometimes may be incorrect and some customers may wish to customize routes for their vehicles. Customer-specific road edits may enable customers to make their own road edits (e.g., freely correct map data and generate customized routes). For example, if path A is a best route, a customer may wish to avoid some roads on path A, and may provide a road edit to close a link on path A so that path B may be returned as the best route. Since the road edit is customer specific, the road edit may only apply to the customer and may not affect other customers (e.g., other vehicles may still take path A). In some implementations, the routing system 105 may continuously receive new road edits and may execute a rebuild contraction hierarchy model to generate updated network data so that road changes may be reflected in routes.

As further shown in FIG. 1A, and by reference number 120, the routing system 105 may identify paths and shortcut paths, of the initial contraction hierarchy, with changed costs due to the road edit. For example, the routing system 105 may analyze links and shortcut paths from the initial contraction hierarchy, and may determine which links and shortcut paths have changed costs due to the road edit and based on analyzing the links and shortcut paths from the initial contraction hierarchy. In some implementations, the changed costs may include changes to link costs of the initial contraction hierarchy, changes to turn costs of the initial contraction hierarchy, changes to conditional costs of the initial contraction hierarchy, and/or the like.

As shown in FIG. 1B, and by reference number 125, the routing system 105 may create an index mapping witness paths to unnecessary candidate shortcut paths, of the initial contraction hierarchy, based on the identified paths and shortcut paths. For example, the routing system 105 may identify witness paths to unnecessary candidate shortcut paths of the initial contraction hierarchy based on the identified paths and shortcut paths. A candidate shortcut path may be deemed unnecessary based on a witness path being associated with the candidate shortcut path. For example, if a candidate shortcut path is S-C-T (e.g., for a source node S, a target node T, and a contracted node C) and a witness path W from node S to node Tis found which has lower cost than the path S-C-T, the routing system 105 may add an entry to the index mapping the witness path W to the candidate shortcut path S-C-T. The routing system 105 may create the index mapping the witness paths to the unnecessary candidate shortcut paths of the initial contraction hierarchy, and may store the index in a data structure (e.g., a database, a table, a list, and/or the like) associated with the routing system 105.

As shown in FIG. 1C, and by reference number 130, the routing system 105 may examine pairs of incoming and outgoing links, for each node of the initial contraction hierarchy, to generate candidate shortcut paths. For example, the routing system 105 may examine pairs of incoming and outgoing links, for each of the plurality of nodes of the initial contraction hierarchy, to determine candidate shortcut paths for the initial contraction hierarchy. In some implementations, when examining the pairs of incoming and outgoing links, for each of the plurality of nodes of the initial contraction hierarchy, to generate the candidate shortcut paths, the routing system 105 may examine pairs of turn-in and turn-out links to and from the candidate shortcut paths. Further details of examining pairs of turn-in and turn-out links to and from the candidate shortcut paths are provided below in connection with FIG. 1H.

As shown in FIG. 1D, and by reference number 135, the routing system 105 may determine whether each of the candidate shortcut paths is required due to the road edit and may identify required candidate shortcut paths. For example, the routing system 105 may determine which of the candidate shortcut paths is required due to the road edit and may identify the required candidate shortcut paths as the candidate shortcut paths that are required due to the road edit. In some implementations, the routing system 105 may focus solely on adding shortcut paths that have become necessary. Identifying possible cases where a new shortcut path may be required is a far easier task than removing unnecessary shortcut paths. For example, processing tens or hundreds of thousands of road edits by the routing system 105 indicates that performance of the routing system 105 is not significantly affected by the now unnecessary shortcut paths remaining in the contraction hierarchy. A candidate shortcut path not being created during an initial contraction may suggest that a witness path was found having a lower cost than the candidate shortcut path. If the road network is edited, the candidate shortcut path may be required to be added since the candidate shortcut path is now an optimal path from a source node to a target node.

In some implementations, when determining whether each of the candidate shortcut paths is required due to the road edit, the routing system 105 may determine whether each of the candidate shortcut paths has become cheaper (e.g., by a closed road being opened) than the same candidate shortcut path before the road edit; whether a witness path has become more expensive than the same witness path before the road edit; or if one of the links is a newly added shortcut. Any candidate shortcut path whose cost has stayed the same or become more expensive, and whose witness path's cost has stayed the same or become cheaper, may remain unnecessary as the witness path found in the initial contraction hierarchy is still necessarily a valid witness path after including the changed costs. Any candidate shortcut paths that either have themselves become cheaper, or whose witness path has become more expensive has the potential of requiring a new shortcut. It is not guaranteed that such a candidate shortcut path will be added to the initial contraction hierarchy. For these candidate shortcut paths, the routing system 105 may repeat the witness search from S to T to determine if there is an alternative witness path that means the shortcut is still unnecessary, or if the shortcut is now necessary.

As shown in FIG. 1E, and by reference number 140, the routing system 105 may determine whether each of the required candidate shortcut paths is associated with a witness path. For example, the routing system 105 may determine whether each of the required candidate shortcut paths is associated with a witness path provided in the index that maps witness paths to unnecessary candidate shortcut paths. In some implementations, the routing system 105 may consult the index of witness paths to candidate shortcuts in order to determine which candidate shortcuts may now be required (e.g., and thus must have their witness searches repeated). In terms of repeating the witness search, the routing system 105 may perform a completely new bidirectional Dijkstra search to determine if there is an alternative witness path. This search may identify the same witness path that was used in the initial preprocessing (e.g., a witness path may have increased in cost from 40 to 50, but if the candidate shortcut cost is 60 then the witness is still valid).

In this way, the routing system 105 may determine, for each pair of incoming and outgoing links to and from a node, whether a candidate shortcut path needs to be reconsidered. During the initial contraction phase of the contraction hierarchy, the routing system 105 may create the index mapping witness paths (e.g., both links and turns between links) to incoming-outgoing link pairs that would constitute shortcut paths in the absence of the witnesses. When responding to a link's cost increasing due to a road edit, the routing system 105 may examine the index if the link was part of a witness path for any candidate shortcut paths in the initial build. Further details of determining whether each of the required candidate shortcut paths is associated with a witness path are provided below in connection with FIG. 1H.

As further shown in FIG. 1E, and by reference number 145, the routing system 105 may add the required candidate shortcut paths, not associated with witness paths, to the initial contraction hierarchy to generate a modified contraction hierarchy. For example, the routing system 105 may add the other portion of the required candidate shortcut paths, that are not associated with witness paths provided in the index, to the initial contraction hierarchy. The initial contraction hierarchy with the added required candidate shortcut paths may generate the modified contraction hierarchy (e.g., a contraction hierarchy that considers the road edit). In some implementations, the routing system 105 may maintain the portion of the required candidate shortcut paths, that are associated with witness paths provided in the index, in the initial contraction hierarchy. Maintaining the portion of the required candidate shortcut paths, that are associated with witness paths provided in the index, may conserve processing resources, networking resources, and/or the like associated with unnecessarily removing the required candidate shortcut paths from the initial contraction hierarchy.

As shown in FIG. 1F, and by reference number 150, the routing system 105 may generate modified routing data based on the modified contraction hierarchy. For example, the routing system 105 may calculate a modified route from the current location to the destination location based on the modified contraction hierarchy. The routing system 105 may generate the modified routing data for the modified route. The modified routing data may include data identifying roads, turns, landmarks, and/or the like that, if followed, will cause the vehicle to travel from the current location to the destination location. In some implementations, the modified routing data may include data identifying a least expensive route from a current location of the vehicle to the destination location of the vehicle based on the road edit.

As further shown in FIG. 1F, and by reference number 155, the routing system 105 may provide the modified routing data to the vehicle. For example, the routing system 105 may provide the modified routing data to the vehicle, and the vehicle may receive the modified routing data. The vehicle may utilize the modified routing data for traveling to the destination location.

FIG. 1G depicts example contraction hierarchies associated with determining whether each of the candidate shortcut paths is required due to the road edit. As shown at the top of FIG. 1G, the routing system 105 may compare an edited candidate shortcut cost with an initial candidate shortcut cost to determine whether a witness search is to be repeated (e.g., since a former witness may no longer be valid). For example, if the road edit lowers the link cost to fifteen (15), the routing system may have to repeat the witness search, but this time the candidate shortcut cost would be thirty five (35) and when a bidirectional Dijkstra witness search is conducted, the routing system 105 may identify the same witness path with a cost of thirty (30) (e.g., proving that the shortcut is still not needed). The candidate shortcut path (shown by solid lines S-C-T) may originally include a cost of forty (40) but the road edit may cause the cost to be reduced to twenty-five (25). The witness path (shown by dashed lines) may include a cost of thirty (30) that remains unchanged after the road edit. In such an example, since the cost of the candidate shortcut path is less than the cost of the witness path, after the road edit, the candidate shortcut path may be required.

As shown at in the middle of FIG. 1G, the routing system 105 may determine whether the former witness path has become more expensive (e.g., by a road being closed) than the candidate shortcut path based on comparing the cost of the candidate shortcut path before and after the road edit is applied. For example, if the middle witness link has its cost increased to fifteen (15) while the left witness link has its cost decreased to five (5), the routing system 105 may repeat the witness search as a result of the increasing cost in the middle link, despite the fact that the total cost of the witness path is unchanged. The candidate shortcut path (shown by solid lines S-C-T) may include a cost of forty (40) that remains unchanged after the road edit. The witness path (shown by dashed lines) may originally include a cost of thirty (30) and may include a cost of fifty (50) after the road edit is applied. In such an example, since the cost of the candidate shortcut path is less than the cost of the witness path, after the road edit, the candidate shortcut path may be required.

As shown at the bottom of FIG. 1G, a shortcut path (shown by solid lines) may include nodes A, B, C, and D. Node B may include the lowest priority and may therefore be contracted first. During the initial contraction, a witness path W (shown by dashed lines) is found and a shortcut is not added from node A to node C. Subsequently, when node Cis contracted, no shortcut from node A to node D can be created since node A is not a neighbor of node C due to the lack of a shortcut from node A to node C. If an edit is made such that a link on the witness path is no longer feasible (as shown by the “X”), when node B is contracted again, there is no witness path and a shortcut path S (shown as a dashed and dotted line) is created from node A to node C. When node Cis contracted, the path A-C-D may be examined as a candidate for a new shortcut path since the incoming link to Cis itself a new shortcut path.

The top of FIG. 1H depicts an example contraction hierarchy associated with determining whether each of the required candidate shortcut paths is associated with a witness path. As shown, a path (W₁, W₂, W₃, W₄) is a witness path for a candidate shortcut path S-C-T. The following entries may be provided in an index mapping the witness paths and candidate shortcut paths: Link W₁→Candidate Shortcut S-C-T; Link W₂→Candidate Shortcut S-C-T; Link W₃→Candidate Shortcut S-C-T; Link W₄→Candidate Shortcut S-C-T; Turn W₁-W₂→Candidate Shortcut S-C-T; Turn W₂-W₃→Candidate Shortcut S-C-T; and Turn W₃-W₄→Candidate Shortcut S-C-T. During generation of the modified contraction hierarchy, if any of the links or turns have increased in cost due to road edits, the routing system 105 may, after consulting the index, flag the candidate shortcut S-C-T as needing to be reconsidered.

The middle and bottom of FIG. 1H depict example contraction hierarchies associated examining pairs of turn-in and turn-out links to and from the candidate shortcut paths. As shown at the middle of FIG. 1H, the routing system 105 may analyze a candidate shortcut path from node S to node T while contracting node C, and may identify a witness path W that has lower cost than the candidate shortcut path. However, when examining the path from turn-in link TI1 or to turn-out link TO1, the witness path may have higher cost than the candidate shortcut path due to the more expensive turns from TI1 and to TO1. As a result, the witness may only be valid when examining the path from turn-in link TI2 and to turn-in link TO2. If a witness path is not found when examining the candidate shortcut path with other turn-in-turn-out pairs, the routing system 105 may create a shortcut for the candidate path S-C-T, but may restrict the usage of this shortcut such that it cannot be traversed when turning in from TI2 and turning out to TO2. Since there is a turn-in-turn-out pair for which the shortcut is not enable, the routing system 105 may determine whether the add the shortcut as a new shortcut. In some examples, the turn cost from a turn-in link to the candidate shortcut path or the turn cost from the candidate shortcut path to a turn-out link may become cheaper due to road edits. In such an example, the routing system 105 may perform a witness search for the turn-in/turn-out pairs.

As shown at the middle of FIG. 1H, the turn cost from TI2 may be reduced, which may render the paths from TI2 to TO1, and from TI2 to TO2, cheaper. The routing system 105 may perform a witness search for the path from TI2 to TO2 to determine if the shortcut is now needed for this turn-in/turn-out pair, as the witness path may no longer be cheaper than the shortcut path. The path from TI2 to TO1 need not be examined since a witness for this path was not previously found and therefore the shortcut for this path was enabled.

FIG. 1I depicts example conditional contraction hierarchies. A candidate shortcut path may be reexamined if either a witness path from the initial contraction has become more expensive, or the candidate shortcut path itself has become cheaper. When introducing conditional costs, these definitions relax to cover situations where a link or a path can possibly have become more expensive or cheaper, respectively, under some conditions. For example, consider a link with a condition stating that it is prohibited for vehicles of height 450 cm and above. If an edit is introduced that changes the height limit to 460 cm (making the limit less restrictive), then for vehicles of height 450 cm-459 cm, the cost of the link decreases (it is no longer prohibited). Conversely if an edit is introduced that changes the height limit to 440 cm (making the limit more restrictive), then for vehicles of height 440 cm-449 cm, the cost of the link increases (it is now prohibited). This updated definition may be used when determining if a candidate shortcut needs to be reexamined.

As shown at the top of FIG. 1I, a dashed line path W₀, W₁, W₂ is a witness for the candidate shortcut path SC0, SC1 from node S to node T. A link W₁ may be prohibited for vehicles of height 450 cm and above, while a link SC0 may be prohibited for vehicles of height 430 cm and above. The restriction on link W₁ may be less restrictive than the restriction on link SC0 (e.g., any vehicle violating the 450 cm restriction must also be violating the 430 cm restriction) so the witness path may be valid in all cases and the shortcut may be deemed unnecessary.

As shown at the middle of FIG. 1I, an edit may be added prohibiting link W₀ for vehicles of length 1900 cm and above. This means that under some circumstances (namely, for vehicles 1900 cm and above), the former witness path may be become more expensive, and the candidate shortcut path may be reexamined. Upon repeating the witness search, the routing system 105 may determine that the former witness is not valid for vehicles of length 1900 cm and above, may not identify other witness, and may add a new shortcut.

As shown at the bottom of FIG. 1I, an edit may be added relaxing the restriction on SC0 to a limit of 460 cm instead of 430 cm. Therefore, for vehicles of height 430 cm-459 cm, the candidate shortcut path has become cheaper and may be reexamined. Upon repeating the witness search, the routing system 105 may determine that the height restriction on the witness path is now more restrictive than the height restriction on the candidate shortcut path, meaning it is not a valid witness. If no other witness are found, the routing system 105 may add a new shortcut.

In this way, the routing system 105 responds to road changes with conditional contraction hierarchies. For example, the routing system 105 may rebuild portions of a contraction hierarchy that are affected by road edits or changes, and may integrate with conditional contraction hierarchies to enable conditional edits (e.g., changing of a vehicle height requirement, changing of a vehicle weight requirement, changing of vehicle length limits, driver-specific road edits, and/or the like). The routing system 105 may trigger the rebuilding of contraction hierarchy data and may subsequently provide rebuilt contraction hierarchy data to be used in routing modification. Thus, the routing system 105 may conserve computing resources, networking resources, and/or other resources that would have otherwise been consumed by completely reperforming the contraction hierarchy based on the road changes, reconstructing a route based on completely reperforming the contraction hierarchy, removing shortcuts that are no longer necessary because of the road changes, and/or the like.

As indicated above, FIGS. 1A-1I are provided as an example. Other examples may differ from what is described with regard to FIGS. 1A-1I. The number and arrangement of devices shown in FIGS. 1A-1I are provided as an example. In practice, there may be additional devices, fewer devices, different devices, or differently arranged devices than those shown in FIGS. 1A-1I. Furthermore, two or more devices shown in FIGS. 1A-1I may be implemented within a single device, or a single device shown in FIGS. 1A-1I may be implemented as multiple, distributed devices. Additionally, or alternatively, a set of devices (e.g., one or more devices) shown in FIGS. 1A-1I may perform one or more functions described as being performed by another set of devices shown in FIGS. 1A-1I.

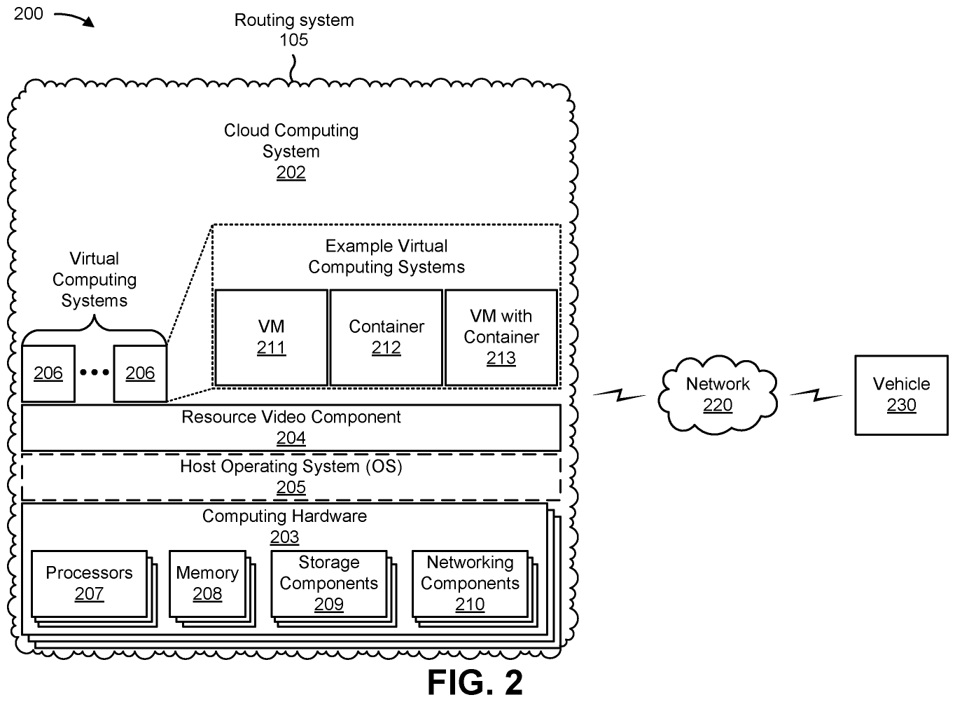

FIG. 2 is a diagram of an example environment 200 in which systems and/or methods described herein may be implemented. As shown in FIG. 2, the environment 200 may include the routing system 105, which may include one or more elements of and/or may execute within a cloud computing system 202. The cloud computing system 202 may include one or more elements 203-213, as described in more detail below. As further shown in FIG. 2, the environment 200 may include a network 220 and/or a vehicle 230. Devices and/or elements of the environment 200 may interconnect via wired connections and/or wireless connections.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

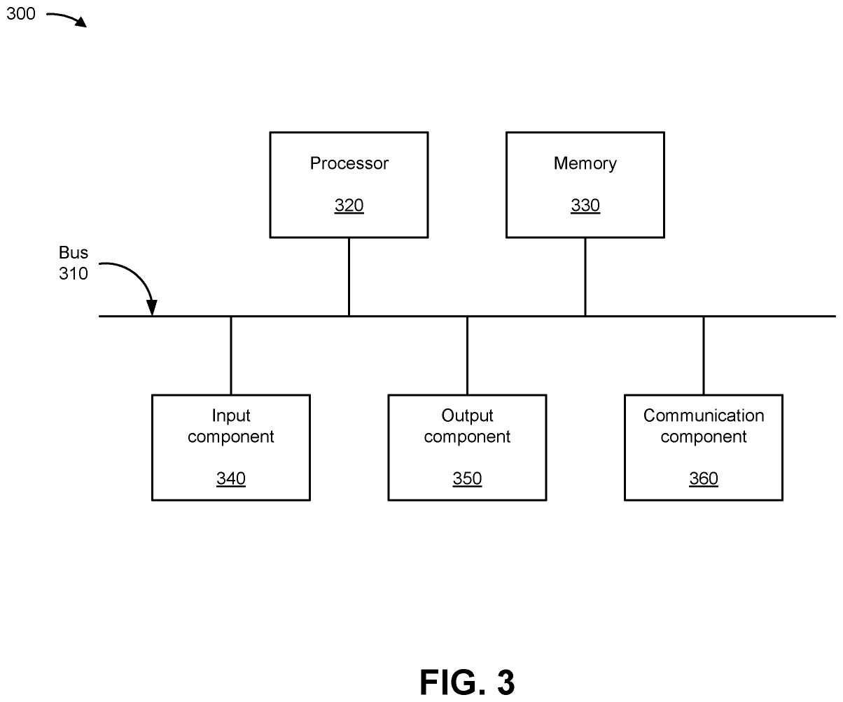

Although the routing system 105 may include one or more elements 203-213 of the cloud computing system 202, may execute within the cloud computing system 202, and/or may be hosted within the cloud computing system 202, in some implementations, the routing system 105 may not be cloud-based (e.g., may be implemented outside of a cloud computing system) or may be partially cloud-based. For example, the routing system 105 may include one or more devices that are not part of the cloud computing system 202, such as a device 300 of FIG. 3, which may include a standalone server or another type of computing device. The routing system 105 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The vehicle 230 may include a car, a truck, a motorcycle, a bus, a boat, farm equipment, construction equipment, and/or the like. In some examples, the vehicle 230 may include an autonomous vehicle, a semiautonomous vehicle, or a non-autonomous vehicle. In some implementations, the vehicle 230 may include a vehicle device capable of receiving, generating, storing, processing, and/or providing information, as described elsewhere herein. The vehicle device may include a communication device and/or a computing device. For example, the vehicle device may include a telematics device, a video camera, a dashboard camera, an inertial measurement unit, a three-axis accelerometer, a gyroscope, a global positioning system (GPS) device, an on-board diagnostics (OBD) device, a vehicle tracking unit, an electronic control unit (ECU), a user device (e.g., a cellular telephone, a laptop computer, and/or the like), and/or the like.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the vehicle and/or the routing system 105. In some implementations, the vehicle and/or the routing system 105 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

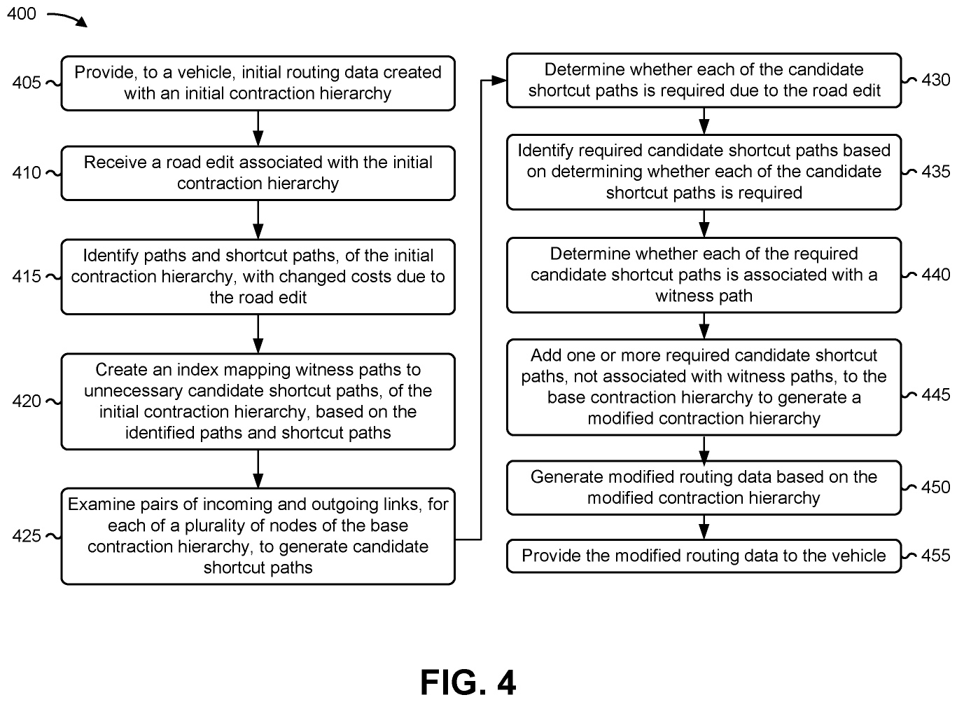

FIG. 4 depicts a flowchart of an example process 400 for responding to road changes with conditional contraction hierarchies. In some implementations, one or more process blocks of FIG. 4 may be performed by a device (e.g., the routing system 105). In some implementations, one or more process blocks of FIG. 4 may be performed by another device or a group of devices separate from or including the device, such as a vehicle (e.g., the vehicle 230). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include providing, to a vehicle, initial routing data created with an initial contraction hierarchy (block 405). For example, the device may provide, to a vehicle, initial routing data created with an initial contraction hierarchy, as described above. In some implementations, the initial contraction hierarchy is a conditional contraction hierarchy. In some implementations, the initial contraction hierarchy is a partitioned contraction hierarchy. In some implementations, the initial routing data includes data identifying a least expensive route from a current location of the vehicle to a destination of the vehicle.

As further shown in FIG. 4, process 400 may include receiving a road edit associated with the initial contraction hierarchy (block 410). For example, the device may receive a road edit associated with the initial contraction hierarchy, as described above. In some implementations, the road edit is associated with one or more of a change to a link cost, a change to a turn cost, or a change to a conditional cost. In some implementations, the road edit includes one or more of a global road edit associated with real time traffic incidents and updates to map data, or a driver-specific road edit associated with a requirement of a driver of the vehicle.

As further shown in FIG. 4, process 400 may include identifying paths and shortcut paths, of the initial contraction hierarchy, with changed costs due to the road edit (block 415). For example, the device may identify paths and shortcut paths, of the initial contraction hierarchy, with changed costs due to the road edit, as described above.

As further shown in FIG. 4, process 400 may include creating an index mapping witness paths to unnecessary candidate shortcut paths, of the initial contraction hierarchy, based on the identified paths and shortcut paths (block 420). For example, the device may create an index mapping witness paths to unnecessary candidate shortcut paths, of the initial contraction hierarchy, based on the identified paths and shortcut paths, as described above. In some implementations, each of the witness paths is associated with a link and a turn between links.

As further shown in FIG. 4, process 400 may include examining pairs of incoming and outgoing links, for each of a plurality of nodes of the initial contraction hierarchy, to generate candidate shortcut paths (block 425). For example, the device may examine pairs of incoming and outgoing links, for each of a plurality of nodes of the initial contraction hierarchy, to generate candidate shortcut paths, as described above. In some implementations, examining the pairs of incoming and outgoing links, for each of the plurality of nodes of the initial contraction hierarchy, to generate the candidate shortcut paths includes examining pairs of turn-in and turn-out links to and from the candidate shortcut paths.

As further shown in FIG. 4, process 400 may include determining whether each of the candidate shortcut paths is required due to the road edit (block 430). For example, the device may determine whether each of the candidate shortcut paths is required due to the road edit, as described above. In some implementations, determining whether each of the candidate shortcut paths is required due to the road edit comprises one or more of determining whether each of the candidate shortcut paths has become cheaper than a former witness path, determining whether a former witness path has become more expensive than each of the candidate shortcut paths, or determining whether one or more links of each of the candidate shortcut paths are newly created shortcuts. In some implementations, determining whether each of the candidate shortcut paths is required due to the road edit includes comparing a cost of each of the candidate shortcut paths before and after the road edit to determine whether each of the candidate shortcut paths is required due to the road edit.

As further shown in FIG. 4, process 400 may include identifying required candidate shortcut paths based on determining whether each of the candidate shortcut paths is required (block 435). For example, the device may identify required candidate shortcut paths based on determining whether each of the candidate shortcut paths is required, as described above.

As further shown in FIG. 4, process 400 may include determining whether each of the required candidate shortcut paths is associated with a witness path (block 440). For example, the device may determine whether each of the required candidate shortcut paths is associated with a witness path, as described above.

As further shown in FIG. 4, process 400 may include adding one or more required candidate shortcut paths, not associated with witness paths, to the initial contraction hierarchy to generate a modified contraction hierarchy (block 445). For example, the device may add one or more required candidate shortcut paths, not associated with witness paths, to the initial contraction hierarchy to generate a modified contraction hierarchy, as described above.

As further shown in FIG. 4, process 400 may include generating modified routing data based on the modified contraction hierarchy (block 450). For example, the device may generate modified routing data based on the modified contraction hierarchy, as described above. In some implementations, the modified routing data includes data identifying a least expensive route from a current location of the vehicle to a destination of the vehicle based on the road edit.

As further shown in FIG. 4, process 400 may include providing the modified routing data to the vehicle (block 455). For example, the device may provide the modified routing data to the vehicle, as described above.

In some implementations, process 400 includes identifying unrequired candidate shortcut paths based on determining whether each of the candidate shortcut paths is required, and maintaining the unrequired candidate shortcut paths in the initial contraction hierarchy. In some implementations, process 400 includes maintaining one or more required candidate shortcut paths, associated with witness paths, in the initial contraction hierarchy.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
providing, by a device and to a vehicle, initial routing data created with an initial contraction hierarchy;
receiving, by the device, a road edit associated with the initial contraction hierarchy;
identifying, by the device, paths and shortcut paths, of the initial contraction hierarchy, with changed costs due to the road edit;
creating, by the device, an index mapping witness paths to unnecessary candidate shortcut paths, of the initial contraction hierarchy, based on the identified paths and shortcut paths;
examining, by the device, pairs of incoming and outgoing links, for each of a plurality of nodes of the initial contraction hierarchy, to generate candidate shortcut paths;
determining, by the device, whether each of the candidate shortcut paths is required due to the road edit;
identifying, by the device, required candidate shortcut paths based on determining whether each of the candidate shortcut paths is required;
determining, by the device, whether each of the required candidate shortcut paths is associated with a witness path;
adding, by the device, one or more required candidate shortcut paths, not associated with witness paths, to the initial contraction hierarchy to generate a modified contraction hierarchy;
generating, by the device, modified routing data based on the modified contraction hierarchy; and
providing, by the device, the modified routing data to the vehicle.

2. The method of claim 1, wherein the initial contraction hierarchy is a conditional contraction hierarchy.

3. The method of claim 1, wherein the road edit is associated with one or more of:
a change to a link cost,
a change to a turn cost, or
a change to a conditional cost.

4. The method of claim 1, further comprising:
identifying unrequired candidate shortcut paths based on determining whether each of the candidate shortcut paths is required; and
maintaining the unrequired candidate shortcut paths in the initial contraction hierarchy.

5. The method of claim 1, further comprising:
maintaining one or more required candidate shortcut paths, associated with witness paths, in the initial contraction hierarchy.

6. The method of claim 1, wherein each of the witness paths is associated with a link and a turn between links.

7. The method of claim 1, wherein examining the pairs of incoming and outgoing links, for each of the plurality of nodes of the initial contraction hierarchy, to generate the candidate shortcut paths comprises:
examining pairs of turn-in and turn-out links to and from the candidate shortcut paths.

8. A device, comprising:
one or more processors configured to:
receive a road edit associated with an initial contraction hierarchy used to generate initial routing data provided to a vehicle;
identify paths and shortcut paths, of the initial contraction hierarchy, with changed costs due to the road edit;
create an index mapping witness paths to unnecessary candidate shortcut paths, of the initial contraction hierarchy, based on the identified paths and shortcut paths;
examine pairs of incoming and outgoing links, for each of a plurality of nodes of the initial contraction hierarchy, to generate candidate shortcut paths;
determine whether each of the candidate shortcut paths is required due to the road edit;
identify required candidate shortcut paths based on determining whether each of the candidate shortcut paths is required;
determine whether each of the required candidate shortcut paths is associated with a witness path;
add one or more required candidate shortcut paths, not associated with witness paths, to the initial contraction hierarchy to generate a modified contraction hierarchy;
generate modified routing data based on the modified contraction hierarchy; and
provide the modified routing data to the vehicle.

9. The device of claim 8, wherein the initial contraction hierarchy is a partitioned contraction hierarchy.

10. The device of claim 8, wherein the initial routing data includes data identifying a least expensive route from a current location of the vehicle to a destination of the vehicle.

11. The device of claim 8, wherein the modified routing data includes data identifying a least expensive route from a current location of the vehicle to a destination of the vehicle based on the road edit.

12. The device of claim 8, wherein the road edit includes one or more of:
a global road edit associated with real time traffic incidents and updates to map data, or
a driver-specific road edit associated with a requirement of a driver of the vehicle.

13. The device of claim 8, wherein the one or more processors, to determine whether each of the candidate shortcut paths is required due to the road edit, are configured to one or more of:
determine whether each of the candidate shortcut paths has become cheaper than a former witness path;
determine whether a former witness path has become more expensive than each of the candidate shortcut paths; or
determine whether one or more links of each of the candidate shortcut paths are newly created shortcuts.

14. The device of claim 8, wherein the one or more processors, to determine whether each of the candidate shortcut paths is required due to the road edit, are configured to:
compare a cost of each of the candidate shortcut paths before and after the road edit to determine whether each of the candidate shortcut paths is required due to the road edit.

15. A non-transitory computer-readable medium storing a set of instructions, the set of instructions comprising:
one or more instructions that, when executed by one or more processors of a device, cause the device to:
provide, to a vehicle, initial routing data created with an initial contraction hierarchy;
receive a road edit associated with the initial contraction hierarchy,
wherein the road edit is associated with one or more of a change to a link cost, a change to a turn cost, or a change to a conditional cost;
identify paths and shortcut paths, of the initial contraction hierarchy, with changed costs due to the road edit;
create an index mapping witness paths to unnecessary candidate shortcut paths, of the initial contraction hierarchy, based on the identified paths and shortcut paths;
examine pairs of incoming and outgoing links, for each of a plurality of nodes of the initial contraction hierarchy, to generate candidate shortcut paths;
determine whether each of the candidate shortcut paths is required due to the road edit;
identify required candidate shortcut paths based on determining whether each of the candidate shortcut paths is required;
determine whether each of the required candidate shortcut paths is associated with a witness path;
add one or more required candidate shortcut paths, not associated with witness paths, to the initial contraction hierarchy to generate a modified contraction hierarchy;
generate modified routing data based on the modified contraction hierarchy; and
provide the modified routing data to the vehicle.

16. The non-transitory computer-readable medium of claim 15, wherein the one or more instructions further cause the device to:
identify unrequired candidate shortcut paths based on determining whether each of the candidate shortcut paths is required; and
maintain the unrequired candidate shortcut paths in the initial contraction hierarchy.

17. The non-transitory computer-readable medium of claim 15, wherein the one or more instructions further cause the device to:
maintain one or more required candidate shortcut paths, associated with witness paths, in the initial contraction hierarchy.

18. The non-transitory computer-readable medium of claim 15, wherein the one or more instructions, that cause the device to examine the pairs of incoming and outgoing links, for each of the plurality of nodes of the initial contraction hierarchy, to generate the candidate shortcut paths, cause the device to:
examine pairs of turn-in and turn-out links to and from the candidate shortcut paths.

19. The non-transitory computer-readable medium of claim 15, wherein the one or more instructions, that cause the device to determine whether each of the candidate shortcut paths is required due to the road edit, cause the device to one or more of:
determine whether each of the candidate shortcut paths has become cheaper than a former witness path;
determine whether a former witness path has become more expensive than each of the candidate shortcut paths; or
determine whether one or more links of each of the candidate shortcut paths are newly created shortcuts.

20. The non-transitory computer-readable medium of claim 15, wherein the one or more instructions, that cause the device to determine whether each of the candidate shortcut paths is required due to the road edit, cause the device to:
compare a cost of each of the candidate shortcut paths before and after the road edit to determine whether each of the candidate shortcut paths is required due to the road edit.
